(19) United States
(12) Patent Application Publication
(10) Pub. No.: US 2023/0002553 A1
(43) Pub. Date: Jan. 5, 2023

(54) FILMS HAVING SPECIAL PROPERTIES

(71) Applicant: Covestro Intellectual Property GmbH & Co. KG, Leverkusen (DE)

(72) Inventors: Heinz PUDLEINER, Krefeld (DE); Georgios TZIOVARAS, Neuss (DE); Kira PLANKEN, Goch (DE); Stefan JANKE, Brüggen (DE); Christoph KOEHLER, Duisburg (DE)

(21) Appl. No.: 17/778,900

(22) PCT Filed: Dec. 10, 2020
(86) PCT No.: PCT/EP2020/085646

§ 371 Date: May 23, 2022

(30) Foreign Application Priority Data
Dec. 12, 2019 (EP) 19215534.9

(51) Int. Cl. C08G 64/06; C08G 64/24; C08J 5/18; C08K 5/42; C09J 7/25; B32B 27/36; B32B 27/32; B32B 27/08; B32B 27/18; B32B 27/10

(52) U.S. Cl. CPC C08G 64/06; C08G 64/24; C08J 5/18; C08K 5/42; C09J 7/25; B32B 27/365; B32B 27/32; B32B 27/08; B32B 27/18; B32B 27/10; C08J 2369/00; C09J 2469/006; B32B 2307/538; B32B 2307/412; B32B 2307/406; B32B 2307/584; B32B 2307/4026; B32B 2250/24; B32B 2250/40

(57) ABSTRACT

The invention relates to a film containing a special polycarbonate or copolycarbonate of the formula (Ia), (I-2), (I-3) or (I-4) and to the use of the film in a security document and in a layer structure.

The invention relates to a film comprising i) a polycarbonate or copolycarbonate of the formula (I-1), (I-2), (I-3) or (I-4), ii) 0.1% to 5% by weight of a first additive; iii) optionally 0.1% to 15% by weight of a second additive other than the first additive, wherein the first additive ii) comprises or is an antistatic compound, and to the use of the film according to the invention in a security document and to the use of component i) for production of a laser-engravable film. The invention further relates to a layer construction comprising the film according to the invention.

For the field of security documents, in particular identification documents, the embedding of a plurality of security features is mandatory, in particular to ensure the originality of these security documents. Such security documents, in particular identification documents, increasingly comprise polycarbonate. Documents based on polycarbonate are particularly durable and exhibit a high level of security against counterfeiting. Popular security features are transparent regions in, for example, identification cards or in data pages of passports. These transparent regions are also called “windows”. Holograms, security marks and other elements which are identifiable as an original or a counterfeit by visual inspection may be introduced into these windows. The functioning of the security feature is based on the high transparency of polycarbonate. If the transparency of the document in the window is impaired then said document may be a counterfeit. The reason for this is as follows: When a further transparent film, for example containing false personal information, is stuck over the document, the change in the window is clearly apparent. The window appears less clear when looking through it. The clarity of the window is likewise disturbed by attempts to open and re-bond the document.

A problem in the manufacture of security documents may firstly be the deformation of the film in production, but also the trapping of air bubbles. Frequently, waves are formed in the individual layers, which are firstly unsightly, but can secondly also have the effect that the data in the security elements cannot always be seen or read out correctly.

Therefore, this invention is concerned with the reduction of at least one of these problems. More particularly, it is an object of the invention to provide very smooth films for security documents, wherein the printed data should have maximum sharpness. It is a further object of the invention to provide smooth films for use in security documents. In addition, it is an object of the invention to provide materials for use in security documents that enable a low level of deformation of the security documents formed therefrom. It is a further object to provide a layer construction that has maximum smoothness and is suitable for production of security documents.

The invention firstly relates to a film comprising
i) 85% to 95% by weight of a polycarbonate or copolycarbonate of the formula (Ia), (I-2), (I-3) or (I-4)

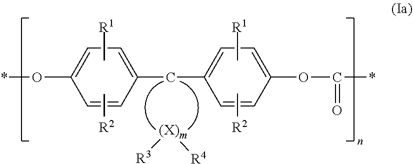

in which
R¹ and R² are independently hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, especially benzyl,
m is an integer from 4 to 7, preferably 4 or 5,
R³ and R⁴ can be chosen individually for each X and are independently hydrogen or C₁-C₆-alkyl and
X is carbon,
with the proviso that, on at least one atom X, R³ and R⁴ are both alkyl, or

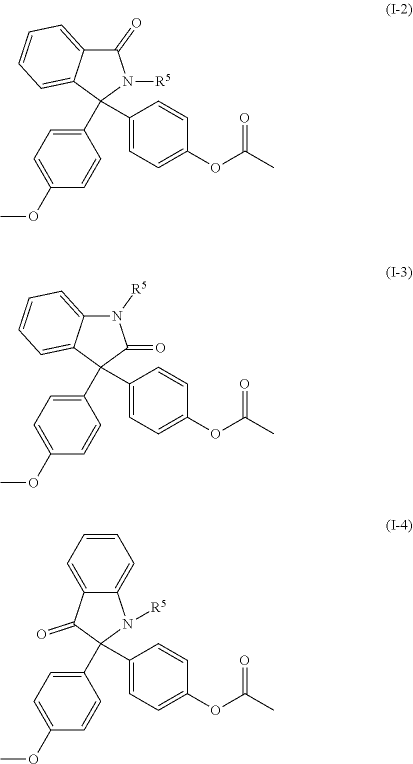

in which R⁵ is a C₁- to C₄-alkyl radical, aralkyl radical or aryl radical, preferably a methyl radical or phenyl radical, most preferably a methyl radical;
ii) 0.1% to 5% by weight of a first additive;
iii) optionally 0.1% to 15% by weight of a second additive other than the first additive,
wherein the first additive ii) comprises or is an antistatic compound.

A very particularly preferred dihydroxydiphenylcycloalkane of formula (Ia) is 1,1-bis(4-hydroxyphenyl)-3,3,5-trimethylcyclohexane (formula (Ia-1) where R¹ and R² represent H).

Polycarbonates of this kind can be prepared according to EP-A 359 953 from dihydroxydiphenylcycloalkanes of the formula (Ia).

Particularly preferred dihydroxyaryl compounds are resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl and 2,2-bis(4-hydroxyphenyl)propane.

It is possible to use either one dihydroxyaryl compound to form homopolycarbonates or different dihydroxyaryl compounds to form copolycarbonates. It is possible to use either one dihydroxyaryl compound of formula (I) or (Ia) to form homopolycarbonates or two or more dihydroxyaryl compounds of formula(e) (I) and/or (Ia) to form copolycarbonates. The various dihydroxyaryl compounds may be interconnected in random or blockwise fashion. In the case of copolycarbonates composed of dihydroxyaryl compounds of formulae (I) and (Ia), the molar ratio of dihydroxyaryl compounds of formula (Ia) to the other dihydroxyaryl compounds of formula (I) that are optionally usable as well is preferably between 99 mol % of (Ia) to 1 mol % of (I) and 2 mol % of (Ia) to 98 mol % of (I), preferably between 99 mol % of (Ia) to 1 mol % of (I) and 10 mol % of (Ia) to 90 mol % of (I), and especially between 99 mol % of (Ia) to 1 mol % of (I) and 30 mol % of (Ia) to 70 mol % of (I).

A very particularly preferred copolycarbonate can be prepared using 1,1-bis(4-hydroxyphenyl)-3,3,5-trimethylcyclohexane and 2,2-bis(4-hydroxyphenyl)propane dihydroxyaryl compounds of formulae (Ia) and (I).

Suitable carbonic acid derivatives may be, for example, diaryl carbonates of general formula (II)

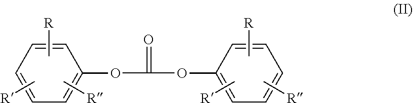

in which
R, R′ and R″ are the same or different and are independently hydrogen, linear or branched C₁-C₃₄-alkyl, C₇-C₃₄-alkylaryl or C₆-C₃₄-aryl, R may additionally also be —COO—R′″ where R′″ is hydrogen, linear or branched C₁-C₃₄-alkyl, C₇-C₃₄-alkylaryl or C₆-C₃₄-aryl.

Preferred diaryl carbonates are, for example, diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4 isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl] carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl] carbonate, di[4-(2-naphthyl)phenyl]carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, diphenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate and di(methyl salicylate) carbonate. Diphenyl carbonate is very particularly preferred.

It is possible to use either one diaryl carbonate or different diaryl carbonates.

For control or variation of the end groups, it is additionally possible to use, for example, one or more monohydroxyaryl compound(s) as chain terminators that were not used for preparation of the diaryl carbonate(s) used. These may be those of the general formula (III)

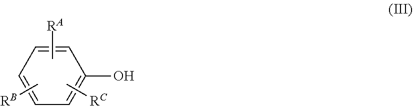

where
R^{A} is linear or branched C₁-C₃₄-alkyl, C₇-C₃₄-alkylaryl, C₆-C₃₄-aryl or —COO—R^{D} where R^{D} is hydrogen, linear or branched C₁-C₃₄-alkyl, C₇-C₃₄-alkylaryl or C₆-C₃₄-aryl, and
R^{B}, R^{C} are the same or different and are independently hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents may include compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl]propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid/trimesoyl chloride, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

As well as the diaryl carbonates, it is also possible to use phosgene in the interfacial process (liquid phase condensation, LPC).

In a preferred configuration of the film, the first additive ii), especially the antistatic compound, is selected from the group consisting of quaternary ammonium or phosphonium salts of a partly fluorinated or perfluorinated organic acid or quaternary ammonium or phosphonium hexafluorophosphates or mixtures of at least two of these.

Such additives and the use thereof as antistats are described in the literature (cf. DE-A 25 06 726, EP-A 1 290 106, EP 897 950 A2 or U.S. Pat. No. 6,372,829).

Examples of useful anions for such salts that are suitable in accordance with the invention as additives are preferably partly fluorinated or perfluorinated alkylsulfonates, cyanoperfluoroalkanesulfonylamides, bis(cyano)perfluoroalkylsulfonylmethides, bis(perfluoroalkylsulfonyl)imides, bis(perfluoroalkylsulfonyl)methides, tris(perfluoroalkylsulfonyl)methides or hexafluorophosphates. Particular preference is given to partly fluorinated or perfluorinated alkylsulfonates, very particular preference to perfluoroalkylsulfonates. As examples of cations of such salts that are suitable in accordance with the invention as additives preferably acyclic or cyclic tertiary or quaternary ammonium or phosphonium cations are possible. Examples of suitable cyclic cations include pyridinium, pyridazidinium, pyrimidiunium, pyrazinium, imidazolium, pyrazolium, thiazolium oxazolim or thiazolium cations. Examples of suitable acyclic cations include those integrated into the formula (IV) below.

Examples of especially preferably suitable quaternary ammonium or phosphonium salts of a perfluoroalkylsulfonic acid are those of the general formula (IV)

R¹—SO₃XR²R³R⁴R⁵ (IV)

in which
X is N or P, preferably N,
R¹ are partly fluorinated or perfluorinated cyclic or linear, branched or unbranched carbon chains having 1 to 30 carbon atoms, preferably 4 to 8 carbon atoms, and in the case of the cyclic radicals preferably those having 5 to 7 carbon atoms,
R² are unsubstituted or halogen-, hydroxy-, cycloalkyl- or alkyl-substituted, especially C₁ to C₃-alkyl- or C₅ to C₇-cycloalkyl-substituted, cyclic or linear, branched or unbranched carbon chains having 1 to 30 carbon atoms, preferably 3 to 10 carbon atoms, and in the case of cyclic radicals preferably those having 5 to 7 carbon atoms, more preferably propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl,
R³, R⁴, R⁵ are each independently unsubstituted or halogen-, hydroxy-, cycloalkyl- or alkyl-substituted, especially C₁ to C₃-alkyl- or C₅ to C₇-cycloalkyl-substituted, cyclic or linear, branched or unbranched carbon chains having 1 to 30 carbon atoms, preferably 1 to 10 carbon atoms, and in the case of cyclic radicals preferably those having 5 to 7 carbon atoms, more preferably methyl, ethyl, propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl.

A preferred selection is that of the ammonium or phosphonium salts in which
X is N or P, preferably N,
R¹ are perfluorinated linear or branched carbon chains having 1 to 30 carbon atoms, preferably 4 to 8 carbon atoms,
R² are each independently halogenated or nonhalogenated linear or branched carbon chains having 1 to 30 carbon atoms, preferably 3 to 10 carbon atoms, more preferably propyl, 1-butyl, 1-pentyl, hexyl, isopropyl, isobutyl, tert-butyl, neopentyl, 2-pentyl, isopentyl, isohexyl,
R³, R⁴, R⁵ are each independently halogenated or nonhalogenated linear or branched carbon chains having 1 to 30 carbon atoms, preferably 1 to 10 carbon atoms, more preferably methyl, ethyl, propyl, 1-butyl, 1-pentyl, hexyl, isopropyl, isobutyl, tert-butyl, neopentyl, 2-pentyl, isopentyl, isohexyl.

Preferentially suitable quaternary ammonium or phosphonium salts are:
tetrapropylammonium perfluorooctanesulfonate,
tetrapropylammonium perfluorobutanesulfonate,
tetrabutylammonium perfluorooctanesulfonate,
tetrabutylammonium perfluorobutanesulfonate,
tetrapentylammonium perfluoroctanesulfonate,
tetrapentylammonium perfluorobutanesulfonate,
tetrahexylammonium perfluoroctanesulfonate,
tetrahexylammonium perfluorobutanesulfonate,
trimethylneopentylammonium perfluorobutanesulfonate,
trimethylneopentylammonium perfluorooctanesulfonate,
dimethyldineopentylammonium perfluorobutanesulfonate,
dimethyldineopentylammonium perfluorooctanesulfonate,
N-methyltripropylammonium perfluorobutylsulfonate,
N-ethyltripropylammonium perfluorobutylsulfonate,
tetrapropylammonium perfluorobutylsulfonate,
diisopropyldimethylammonium perfluorobutylsulfonate,
diisopropyldimethylammonium perfluorooctylsulfonate,
N-methyltributylammonium perfluorooctylsulfonate,
cyclohexyldiethylmethylammonium perfluorooctylsulfonate,
cyclohexyltrimethylammonium perfluorooctylsulfonate
   and the corresponding phosphonium salts. The ammonium salts are preferred.

It is also possible with preference to use one or more of the abovementioned quaternary ammonium or phosphonium salts, i.e. mixtures as well.

The phosphonium sulfate is preferably a fluorinated phosphonium sulfate and is composed of a fluorocarbon containing an organic sulfonate anion and an organic phosphonium cation. Examples of such organic sulfonate anions include perfluoromethanesulfonate, perfluorobutanesulfonate, perfluorohexanesulfonate, perfluoroheptanesulfonate and perfluorooctanesulfonate. Examples of the aforementioned phosphonium cations include aliphatic phosphonium, for example tetramethylphosphonium, tetraethylphosphonium, tetrabutylphosphonium, triethylmethylphosphonium, tributylmethylphosphonium, tributylethylphosphonium, trioctylmethylphosphonium, trimethylbutylphosphonium, trimethyloctylphosphonium, trimethyllaurylphosphonium, trimethylstearylphosphonium, triethyloctylphosphonium, and aromatic phosphonium, for example tetraphenylphosphonium, triphenylmethylphosphonium, triphenylbenzylphosphonium, tributylbenzylphosphonium.

Of the phosphonium salts, preference is given to using tetrabutylphosphonium nonafluorobutylsulfonate.

In a preferred embodiment of the film, the antistatic compound is selected from the group consisting of quaternary ammonium salts of a partly fluorinated or perfluorinated organic acid or quaternary ammonium hexafluorophosphates or mixtures of at least two of these.

Very particular preference is given to tetrapropylammonium perfluorooctanesulfonate, tetrabutylammonium perfluorooctanesulfonate, tetrapentylammonium perfluorooctanesulfonate, tetrahexylammonium perfluorooctanesulfonate and dimethyldiisopropylammonium perfluorooctanesulfonate and the corresponding perfluorobutanesulfonate salts.

In a very particularly preferred embodiment of the invention, diisopropyldimethylammonium perfluorobutylsulfonate is used.

The recited salts are known or are producible by known methods. The salts of the sulfonic acids can be prepared, for example, by combination of equimolar amounts of the free sulfonic acid with the hydroxyl form of the corresponding cation in water at room temperature, and concentration of the solution. Other production processes are described for example in DE-A 1 966 931 and NL-A 7 802 830.

The salts mentioned are preferably added in amounts of 0.001% to 2% by weight, preferably of 0.1% to 1% by weight, based on the total mass of the film prior to shaping thereof, which can be effected, for example, by extrusion or coextrusion.

The above-described film is preferably part of a layer construction, in which case the layer construction also includes at least one further layer of a thermoplastic selected from polymers of ethylenically unsaturated monomers and/or polycondensates of bifunctional reactive compounds, preferably one or more polycarbonates or copolycarbonates based on diphenols, poly- or copolyacrylates and poly- or copolymethacrylates, poly- or copolymers of styrene, thermoplastic polyurethane(s) and polyolefin(s), poly- or copolycondensates of terephthalic acid having a fraction of cyclohexane-1,4-dimethanol, cyclohexane-1,3-dimethanol and/or 2,2,4,4-tetramethylbutane-1,3-diol, preferably cyclohexane-1,4-dimethanol and/or cyclohexane-1,3-dimethanol, poly- or copolycondensates of naphthalenedicarboxylic acid, poly- or copolycondensates of at least one cycloalkyldicarboxylic acid, mixtures thereof or blends thereof, more preferably one or more polycarbonates or copolycarbonates based on diphenols or blends containing at least one polycarbonate or copolycarbonate.

Particularly suitable thermoplastics are polycarbonates or copolycarbonates based on diphenols, poly- or copolyacrylates and poly- or copolymethacrylates, for example and with preference polymethyl methacrylate (PMMA), poly- or copolymers with styrene, for example and with preference polystyrene (PS) or polystyrene acrylonitrile (SAN), thermoplastic polyurethanes and polyolefins, for example and with preference, polypropylene types or polyolefins based on cyclic olefins (for example TOPAS™), poly- or copolycondensates of an aromatic dicarboxylic acid and aliphatic, cycloalophatic and/or araliphatic diols having 2 to 16 carbon atoms, for example and with preference poly- or copolycondensates of terephthalic acid, more preferably poly- or copolyethylene terephthalate (PET or CoPET), glycol-modified PET (PETG), glycol-modified poly- or copolycyclohexanedimethylene terephthalate (PCTG) or poly- or copolybutylene terephthalate (PBT or CoPBT), preferably poly- or copolycondensates of naphthalenedicarboxylic acid, more preferably polyethylene glycol naphthalate (PEN), poly- or copolycondensate(s) of at least one cycloalkyldicarboxylic acid, for example and with preference polycyclohexanedimethanolcyclohexanedicarboxylic acid (PCCD), polysulfones (PSU), polyvinylhalides, for example and with preference polyvinylchloride (PVC), or mixtures of the abovementioned.

Particularly preferred thermoplastics are one or more polycarbonate(s) or copolycarbonate(s) based on diphenols or blends containing at least one polycarbonate or copolycarbonate. Very particular preference is given to blends containing at least one polycarbonate or copolycarbonate and at least one poly- or copolycondensate of terephthalic acid, of naphthalenedicarboxylic acid or of a cycloalkyldicarboxylic acid, preferably of cyclohexanedicarboxylic acid. Preference is further given to blends containing a polycarbonate or copolycarbonate and at least one cyclohexanedicarboxylic copolyester, such as Xylex™ from Sabic. Very particular preference is given to polycarbonates or copolycarbonates, especially having average molecular weights Mw of 500 to 100 000, preferably of 10 000 to 80 000, more preferably of 15 000 to 40 000, or blends thereof with at least one poly- or copolycondensate of terephthalic acid having average molecular weights Mw of 10 000 to 200 000, preferably of 21 000 to 120 000.

Suitable poly- or copolycondensates of terephthalic acid in preferred embodiments of the invention are polyalkylene terephthalates. Suitable polyalkylene terephthalates are, for example, reaction products of aromatic dicarboxylic acids or their reactive derivatives (for example dimethyl esters or anhydrides) and aliphatic, cycloaliphatic or araliphatic diols and mixtures of these reaction products.

Preferred polyalkylene terephthalates can be prepared from terephthalic acid (or reactive derivatives thereof) and aliphatic or cycloaliphatic diols having 2 to 10 C atoms by known methods (Kunststoff-Handbuch [Plastics Handbook], vol. VIII, p. 695 ff, Karl-Hanser-Verlag, Munich 1973).

Preferred polyalkylene terephthalates contain at least 80 mol %, preferably 90 mol %, of terephthalic acid radicals, based on the dicarboxylic acid component, and at least 80 mol %, preferably at least 90 mol %, of ethylene glycol and/or butane-1,4-diol and/or cyclohexane-1,4-dimethanol radicals, based on the diol component.

The preferred polyalkylene terephthalates may contain, in addition to terephthalic acid radicals, up to 20 mol % of radicals of other aromatic dicarboxylic acids having 8 to 14 carbon atoms or of aliphatic dicarboxylic acids having 4 to 12 carbon atoms, such as for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene and/or butane-1,4-diol glycol radicals, up to 80 mol % of other aliphatic diols having 3 to 12 carbon atoms or of cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and 2-ethylhexane-1,6-diol, 2,2-diethylpropane-1,3-diol, hexane-2,5-diol, 1,4-di([beta]-hydroxyethoxy)benzene, 2,2-bis(4-hydroxycyclohexyl)propane, 2,4-dihydroxy-1,1,3,3-tetramethylcyclobutane, 2,2-bis(3-[beta]-hydroxyethoxyphenyl)propane and 2,2-bis(4-hydroxypropoxyphenyl)propane (cf. DE-A 24 07 674, 24 07 776, 27 15 932).

The polyalkylene terephthalates may be branched by incorporation of relatively small amounts of tri- or tetrahydric alcohols or tri- or tetrabasic carboxylic acids, as described for example in DE-A 19 00 270 and U.S. Pat. No. 3,692,744. Examples of preferred branching agents are trimesic acid, trimellitic acid, trimethylolethane and trimethylolpropane and pentaerythritol.

It is preferable when not more than 1 mol % of the branching agent is used, based on the acid component.

Particular preference is given to polyalkylene terephthalates which have been prepared solely from terephthalic acid and the reactive derivatives thereof (e.g. the dialkyl esters thereof) and ethylene glycol and/or butane-1,4-diol and/or cyclohexane-1,4-dimethanol radicals, and to mixtures of these polyalkylene terephthalates.

Preferred polyalkylene terephthalates further include copolyesters produced from at least two of the abovementioned acid components and/or from at least two of the abovementioned alcohol components; particularly preferred copolyesters are poly(ethylene glycol/butane-1,4-diol) terephthalates.

The polyalkylene terephthalates preferably used as component preferably have an intrinsic viscosity of about 0.4 to 1.5 dl/g, preferably 0.5 to 1.3 dl/g, measured in each case in phenol/o-dichlorobenzene (1:1 parts by weight) at 25° C.

In particularly preferred embodiments of the invention the blend of at least one polycarbonate or copolycarbonate with at least one poly- or copolycondensate of terephthalic acid is a blend of at least one polycarbonate or copolycarbonate with poly- or copolybutylene terephthalate or glycol-modified poly- or copolycyclohexanedimethylene terephthalate. Such a blend of polycarbonate or copolycarbonate with poly- or copolybutylene terephthalate or glycol-modified poly- or copolycyclohexanedimethylene terephthalate may preferably be one comprising 1% to 90% by weight of polycarbonate or copolycarbonate and 99% to 10% by weight of poly- or copolybutylene terephthalate or glycol-modified poly- or copolycyclohexanedimethylene terephthalate, preferably comprising 1% to 90% by weight of polycarbonate and 99% to 10% by weight of polybutylene terephthalate or glycol-modified polycyclohexanedimethylene terephthalate, wherein the proportions add up to 100% by weight. Such a blend of polycarbonate or copolycarbonate with poly- or copolybutylene terephthalate or glycol-modified poly- or copolycyclohexanedimethylene terephthalate may more preferably be one comprising 20% to 85% by weight of polycarbonate or copolycarbonate and 80% to 15% by weight of poly- or copolybutylene terephthalate or glycol-modified poly- or copolycyclohexanedimethylene terephthalate, preferably comprising 20% to 85% by weight of polycarbonate and 80% to 15% by weight of polybutylene terephthalate or glycol-modified polycyclohexanedimethylene terephthalate, wherein the proportions add up to 100% by weight. Such a blend of polycarbonate or copolycarbonate with poly- or copolybutylene terephthalate or glycol-modified poly- or copolycyclohexanedimethylene terephthalate may most preferably be one comprising 35% to 80% by weight of polycarbonate or copolycarbonate and 65% to 20% by weight of poly- or copolybutylene terephthalate or glycol-modified poly- or copolycyclohexanedimethylene terephthalate, preferably comprising 35% to 80% by weight of polycarbonate and 65% to 20% by weight of polybutylene terephthalate or glycol-modified polycyclohexanedimethylene terephthalate, wherein the proportions add up to 100% by weight. Very particularly preferred embodiments may involve blends of polycarbonate and glycol-modified polycyclohexanedimethylene terephthalate in the aforementioned compositions.

Suitable polycarbonates or copolycarbonates in preferred embodiments are particularly aromatic polycarbonates or copolycarbonates.

The polycarbonates or copolycarbonates may be linear or branched in known fashion.

These polycarbonates can be prepared in a known manner from diphenols, carbonic acid derivatives, optionally chain terminators and optionally branching agents. Details of the production of polycarbonates have been set out in many patent specifications during the last 40 years or so. Reference may be made here merely by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to Dres. U. Grigo, K. Kirchner and P. R. Müller, “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299.

Suitable diphenols may be, for example, dihydroxyaryl compounds of general formula (I)

HO—Z—OH (I)

in which Z is an aromatic radical which has 6 to 34 carbon atoms and may contain one or more optionally substituted aromatic rings and aliphatic or cycloaliphatic radicals or alkylaryls or heteroatoms as bridging elements.

Examples of suitable dihydroxyaryl compounds include: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

These and further suitable other dihydroxyaryl compounds are described, for example, in DE-A 3 832 396, FR-A 1 561 518, in H. Schnell, Chemistry and Physics of Polycarbonates, Interscience Publishers, New York 1964, p. 28 ff; p. 102 ff, and in D. G. Legrand, J. T. Bendler, Handbook of Polycarbonate Science and Technology, Marcel Dekker New York 2000, p. 72 ff.

Preferred dihydroxyaryl compounds are, for example, resorcinol, 4,4′-dihydroxydiphenyl, bis(4-hydroxyphenyl)methane, bis(3,5-dimethyl-4-hydroxyphenyl)methane, bis(4-hydroxyphenyl)-diphenylmethane, 1,1-bis(4-hydroxyphenyl)-1-phenylethane, 1,1-bis(4-hydroxyphenyl)-1-(1-naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,3-bis[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis[2-(3,5-dimethyl-4-hydroxyphenyl)-2-propyl]benzene, bis(4-hydroxyphenyl) ether, bis(4-hydroxyphenyl) sulfide, bis(4-hydroxyphenyl) sulfone, bis(3,5-dimethyl-4-hydroxyphenyl) sulfone and 2,2′,3,3′-tetrahydro-3,3,3′,3′-tetramethyl-1,1′-spirobi[1H-indene]-5,5′-diol or dihydroxydiphenylcycloalkanes of the formula (Ia)

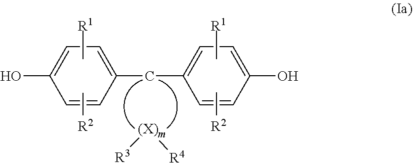

in which
R1 and R2 are independently hydrogen, halogen, preferably chlorine or bromine, C1-C8-alkyl, C5-C6-cycloalkyl, C6-C10-aryl, preferably phenyl, and C7-C12-aralkyl, preferably phenyl-C1-C4-alkyl, especially benzyl,
m is an integer from 4 to 7, preferably 4 or 5,
R3 and R4 can be chosen individually for each X and are independently hydrogen or C1-C6-alkyl and
X is carbon,
with the proviso that, on at least one atom X, R3 and R4 are both alkyl. Preferably, in the formula (Ia), on one or two X atom(s), especially only on one X atom, R3 and R4 are both alkyl.

A preferred alkyl radical for the R3 and R4 radicals in formula (Ia) is methyl. The X atoms in alpha position to the diphenyl-substituted carbon atom (C-1) are preferably not dialkyl-substituted; instead, alkyl disubstitution in the beta position to C-1 is preferred. Particularly preferred dihydroxydiphenylcycloalkanes of the formula (Ia) are those having 5 and 6 ring carbon atoms X in the cycloaliphatic radical (m=4 or 5 in formula (Ia)), for example the diphenols of formulae (Ib), (Ic) or (Id).

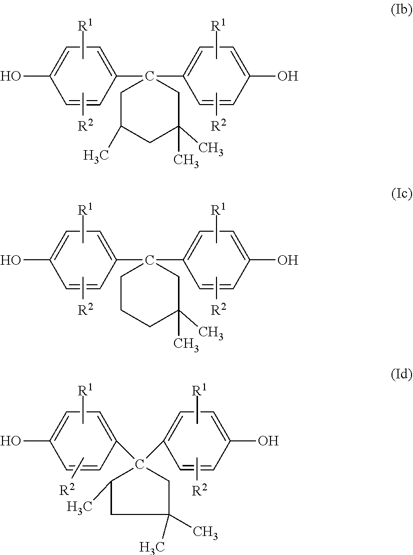

A very particularly preferred dihydroxydiphenylcycloalkane of formula (Ia) is 1,1-bis(4-hydroxyphenyl)-3,3,5-trimethylcyclohexane (formula (Ib) with R1 and R2=H).

Polycarbonates of this kind can be prepared according to EP-A 359 953 from dihydroxydiphenylcycloalkanes of the formula (Ia).

Particularly preferred dihydroxyaryl compounds are resorcinol, 4,4′-dihydroxydiphenyl, bis(4-hydroxyphenyl) diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl and 2,2-bis(4-hydroxyphenyl)propane.

It is possible to use either one dihydroxyaryl compound to form homopolycarbonates or different dihydroxyaryl compounds to form copolycarbonates. It is possible to use either one dihydroxyaryl compound of formula (I) or (Ia) to form homopolycarbonates or two or more dihydroxyaryl compounds of formula(e) (I) and/or (Ia) to form copolycarbonates. The various dihydroxyaryl compounds may be interconnected in random or blockwise fashion. In the case of copolycarbonates composed of dihydroxyaryl compounds of formulae (I) and (Ia), the molar ratio of dihydroxyaryl compounds of formula (Ia) to the other dihydroxyaryl compounds of formula (I) that are optionally usable as well is preferably between 99 mol % of (Ia) to 1 mol % of (I) and 2 mol % of (Ia) to 98 mol % of (I), preferably between 99 mol % of (Ia) to 1 mol % of (I) and 10 mol % of (Ia) to 90 mol % of (I), and especially between 99 mol % of (Ia) to 1 mol % of (I) and 30 mol % of (Ia) to 70 mol % of (I).

A very particularly preferred copolycarbonate can be prepared using 1,1-bis(4-hydroxyphenyl)-3,3,5-trimethylcyclohexane and 2,2-bis(4-hydroxyphenyl)propane dihydroxyaryl compounds of formulae (Ia) and (I).

Suitable carbonic acid derivatives may be, for example, those mentioned under formula (II).

In a preferred configuration of the film, the polycarbonate or copolycarbonate has an average molecular weight Mw within a range from 10 000 to 500 000 g/mol, preferably from 15 000 to 400 000 g/mol, more preferably from 20 000 to 300 000 g/mol.

In a preferred configuration of the film, the polycarbonate or copolycarbonate has been prepared partly from the starting materials selected from the group consisting of:

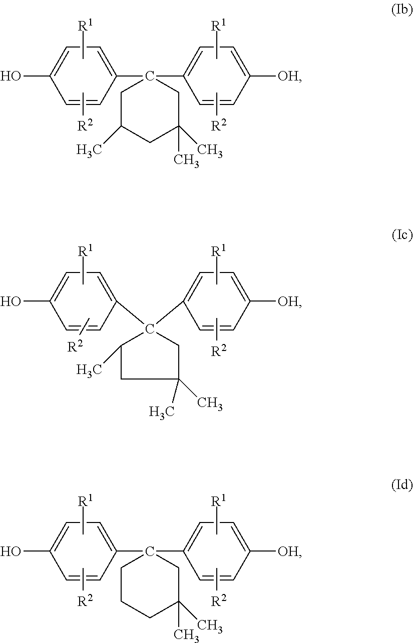

or mixtures of at least two of these.

A very particularly preferred dihydroxydiphenylcycloalkane of formula (Ia) is 1,1-bis(4-hydroxyphenyl)-3,3,5-trimethylcyclohexane (formula (Ib) with R¹ and R²=H).

Polycarbonates of this kind can be prepared according to EP-A 359 953 from dihydroxydiphenylcycloalkanes of the formula (Ia).

Particularly preferred dihydroxyaryl compounds are resorcinol, 4,4′-dihydroxydiphenyl, bis(4-hydroxyphenyl) diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl and 2,2-bis(4-hydroxyphenyl)propane.

It is possible to use either one dihydroxyaryl compound to form homopolycarbonates or different dihydroxyaryl compounds to form copolycarbonates. It is possible to use either one dihydroxyaryl compound of formula (I) or (Ia) to form homopolycarbonates or two or more dihydroxyaryl compounds of formula(e) (I) and/or (Ia) to form copolycarbonates. The various dihydroxyaryl compounds may be interconnected in random or blockwise fashion. In the case of copolycarbonates composed of dihydroxyaryl compounds of formulae (I) and (Ia), the molar ratio of dihydroxyaryl compounds of formula (Ia) to the other dihydroxyaryl compounds of formula (I) that are optionally usable as well is preferably between 99 mol % of (Ia) to 1 mol % of (I) and 2 mol % of (Ia) to 98 mol % of (I), preferably between 99 mol % of (Ia) to 1 mol % of (I) and 10 mol % of (Ia) to 90 mol % of (I), and especially between 99 mol % of (Ia) to 1 mol % of (I) and 30 mol % of (Ia) to 70 mol % of (I).

A very particularly preferred copolycarbonate can be prepared using 1,1-bis(4-hydroxyphenyl)-3,3,5-trimethylcyclohexane and 2,2-bis(4-hydroxyphenyl)propane compounds of the formulae (Ia) and (I).

Suitable carbonic acid derivatives may be, for example, those mentioned under formula (II).

Preferred diaryl carbonates are, for example, diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4-isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl] carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl] carbonate, di[4-(2-naphthyl)phenyl]carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, diphenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate and di(methyl salicylate) carbonate. Diphenyl carbonate is very particularly preferred.

It is possible to use either one diaryl carbonate or different diaryl carbonates.

For control or variation of the end groups, it is additionally possible to use, for example, one or more monohydroxyaryl compound(s) as chain terminators that were not used for preparation of the diaryl carbonate(s) used. These may be those of the general formula (III)

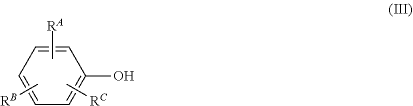

where
R^{A} is linear or branched C₁-C₃₄-alkyl, C₇-C₃₄-alkylaryl, C₆-C₃₄-aryl or —COO—R^{D} where R′ is hydrogen, linear or branched C₁-C₃₄-alkyl, C₇-C₃₄-alkylaryl or C₆-C₃₄-aryl, and
R^{B}, R^{C} are the same or different and are independently hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents may include compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl]propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid/trimesoyl chloride, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

In a preferred configuration of the film, the polycarbonate or copolycarbonate includes the starting compound (Ib) within a range from 10% by weight to 90% by weight, more preferably within a range from 20% by weight to 80% by weight, based on the total mass of the polycarbonate or copolycarbonate, or the polycarbonate or copolycarbonate has a molar ratio of (Ib) to other bisphenol A derivatives within a range from 1:10 to 10:1, preferably within a range from 1:5 to 5:1.

In another preferred embodiment of the film, the film has at least one, preferably at least two and more preferably all of the following properties:
(A) roughness in accordance with ISO 4288:1996 within a range from 2 μm to 30 μm, preferably within a range from 3 μm to 25 μm, more preferably within a range from 5 μm to 20 μm;
(B) transparency within a range from 2% to 92%, measured to ISO 13468-2:2006-07;
(C) gloss within a range from 10 to 110 according to ISO 2813, 2015-02, preferably within a range from 50 to 110, more preferably within a range from 60 to 100, or preferably within a range from 10 to 40, more preferably within a range from 10 to 30;
(D) scratch resistance within a range from 4B to 3H, preferably from 2B to 2H, more preferably from 1B to 1H, measured according to DIN EN ISO 15184-2011-05;
(E) a Vicat softening temperature within a range from 160° C. to 230° C., preferably within a range from 170° C. to 220° C., according to ISO 306:2004 (method B120 50N; 120° C./h);
(F) surface resistance <10¹⁴Ω, preferably <5*10¹³Ω, according to DIN IEC 93:1980 (from Fischer).

The film preferably has one of the following combinations of features: (A) and (B); (A) and (C); (A) and (D); (A) and (E); (A) and (F); (B) and (C); (B) and (D); (B) and (E); (B) and (F); (C) and (D); (C) and (E); (C) and (F); (D) and (E); (D) and (F); (E) and (F); (A), (B) and (C); (A), (B) and (D); (A), (B) and (E); (A), (B) and (F); (B), (C) and (D); (B), (C) and (E); (B), (C) and (F); (C), (D) and (E); (C), (D) and (F); (D), (E) and (F); (A), (B), (C) and (D); (A), (B), (C) and (E); (A), (B), (C) and (F); (B), (C), (D) and (E); (B), (C), (D) and (F); (C), (D), (E), and (F); (A), (B), (C), (D) and (E); (A), (B), (C), (D) and (F); (B), (C), (D), (E) and (F); (A), (B), (C), (D), (E) and (F).

Transparency under (B) depends on the further additives that are added in the production of the film. The film without further additives, i.e. solely with components i), ii) and iii), preferably has transparency within a range from 50% to 92%, further preferably within a range from 70% to 92%.

Gloss under (C) especially varies between the extremes within a range from 10 to 30 according to ISO 2813, 2015-02, when both sides of the film have a matt surface, and the other extreme within a range from 70 to 110 according to ISO 2813, 2015-02, when both sides of the film have a smooth surface.

In a preferred configuration of the film, the further additive is selected from the group consisting of a dye, a pigment or a combination of these. The pigment is preferably selected from the group consisting of a white pigment, a black pigment or a chromatic pigment, especially a white pigment.

In a preferred configuration of the film, the pigment is selected from the group consisting of titanium dioxide, zirconium dioxide, alkaline earth metal carbonate, such as calcium carbonate, and alkaline earth metal sulfate, such as barium sulfate, or a mixture of at least two of these. The film contains the fillers mentioned, such as dye or pigment, each preferably within a range from 2% to 20% by weight, more preferably from 5% to 10% by weight, based on the total weight of the film. The fillers are preferably added in the amounts specified in the production of the film by extrusion or coextrusion, for example. The fillers mentioned are preferably used overall within a range from 2% to 50% by weight, more preferably from 5% to 40% by weight, based on the total weight of the film.

In a preferred configuration of the film, the further additive is introduced into the film by a process having at least the following steps:
D1. at least partly coating the film with a layer containing a dye or pigment,
D2. at least partly irradiating the film from D1. with focused nonionizing electromagnetic radiation,
wherein there is partial coloring of the film only at the sites irradiated in step D2.

The coating in step D1. can be effected by any coating method that a person skilled in the art would select for the purpose. The coating is preferably selected from the group consisting of dipping, printing or a combination of these.

The film is preferably dipped into a coloring bath in order to wet the film and to produce a layer in the form of a color layer on the film. The coloring bath may be heated to a temperature up to 99° C. This allows the intensity of the partial coloring to be improved according to the polymer used in the plastic part. In the case of irradiation of the plastic parts in an autoclave, the coloring bath can also be heated to 150° C. if permitted by the heat distortion resistance of the plastic parts. In a preferred embodiment of the process of the invention, the temperature of the coloring bath is ≤70° C., preferably ≥10° C. to ≤60° C., more preferably ≥15° C. to ≤50° C.

The coloring bath may comprise at least one colorant, preferably at least one dye, more preferably at least one dye from the group of solvent dyes and/or disperse dyes according to the Colour Index classification or mixtures of these dyes.

The Colour Index (CI) of the Society of Dyers and Colourists and the American Association of Textile Chemists and Colorists unambiguously characterizes all colorants via the group name and the number for the chemical composition/chemical structure.

Dyes from the group of solvent dyes according to the Colour Index classification may, for example, be those called the Macrolex® dyes from Lanxess AG, Germany. Examples include Macrolex® Blue 3R, Macrolex® Red H, Macrolex® Yellow 6G (Solvent Yellow 179 according to CI), Macrolex® Violet Red R (Disperse Violet 31 according to CI), Macrolex® Orange R (Solvent Orange 107 according to CI) or mixtures of these dyes.

Dyes from the group of the disperse dyes according to the Colour Index classification may be for example diazo, diphenylamine and anthraquinone compounds, acetate dyes, disperse dyes and/or dispersol dyes and include disperse blue #3, disperse blue #14, disperse yellow #3, disperse red #134 and disperse red #7. The classification and description of the abovementioned dyes is in accordance with “The Colour Index”, 3rd edition, joint publication of the Society of Dyes and Colors and the American Association of Textile Chemists and Colorists (1971). Very generally, the dyes may be used either as a single dye constituent or as a component of a mixture according to the desired color. Thus the term “dye” used here also encompasses dye mixtures.

Suitable dyes include water-insoluble diazo-diphenylamine and anthraquinone compounds. Particularly suitable are acetate dyes, dispersed acetate dyes, dispersion dyes and dispersol dyes, as disclosed in the Colour Index, 3′ edition, volume 2, The Society of Dyers and Colourists, 1971, p. 2479 and 2187-2743.

The preferred dispersed dyes include Dystar's Palanil Blue E-R150 (anthraquinone/disperse blue), DIANIX Orange E-3RN (azo dye/C₁ disperse-Orange 25) and the abovementioned Macrolex® dyes as solvent dyes.

The coloring bath preferably comprises:
a) solvent and/or dispersant, preferably water and/or organic solvent, more preferably water
b) colorant, preferably a dye, more preferably a dye from the solvent dyes and/or disperse dyes according to the Colour Index classification.

Coloring baths of this kind suitable for uniform coloring of polycarbonate plastic parts at temperatures >80° C. have proven advantageous. These are described for example in WO-A 03/040461, EP-A 2050866, WO-A 03/083207. Under the conditions of the process of the invention, essentially partial coloring of the film takes place in the irradiated regions, so that an intense gravure in the form of the layer becomes visible at these specific sites.

The layer containing the dye or pigment preferably contains the dye or pigment in an amount within a range from 1 ppm to 180 ppm, more preferably within a range from 10 ppm to 160 ppm, most preferably within a range from 15 ppm to 100 ppm.

The layer preferably has a thickness within a range from 10 μm to 500 μm, more preferably within a range from 20 μm to 400 μm, most preferably within a range from 50 μm to 200 μm.

The irradiating in step D2. can be effected in any manner that a person skilled in the art would select for the purpose. The irradiating in step D2. is preferably effected with focused nonionizing electromagnetic radiation, preferably focused nonionizing electromagnetic radiation having a wavelength in the range from ≥0.1 μm to ≤1 mm, more preferably in the range from ≥0.15 μm to ≤20 μm, most preferably with laser radiation of wavelength in the range from ≥0.15 μm to ≤20 μm. “Colored” is also understood to mean black or white.

One way of applying a color layer at least partly to the film by dipping and subsequent irradiation is described in US 2019/0106837 A1.

In the context of this invention, what is meant by “essentially” is that a colored element clearly apparent to the eye as a visible colored element is formed only at the sites irradiated in step D2. This does not preclude slight coloring of the plastic part at the non-irradiated sites.

It is a feature of the process of the invention that there is partial coloring of the film, especially containing thermoplastic, essentially at the sites irradiated in step D2. The rest of the film exhibits only very weak coloring, if any, at the nonirradiated regions. It is thus possible to color specific regions of the film in order to apply, for example, an image, personalization, logo, symbol or inscription to the film by the process of the invention. These are not readily removable from the surface of the film. The process of the invention is thus especially suitable for the field of production of security and identification documents.

The invention further relates to the use of a film of the invention including security-relevant data in a security document. Security documents are especially understood to mean documents having security-element information, such as identification cards, passports, driving licenses and the like.

The invention further relates to the use of a polycarbonate or copolycarbonate of the formula (Ia), (I-2), (I-3) or (I-4)

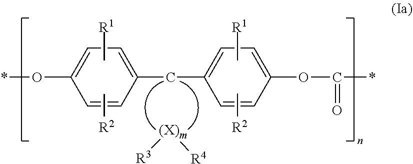

in which
R¹ and R² are independently hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, especially benzyl,
m is an integer from 4 to 7, preferably 4 or 5,
R³ and R⁴ can be chosen individually for each X and are independently hydrogen or C₁-C₆-alkyl and
X is carbon,
with the proviso that, on at least one atom X, R³ and R⁴ are both alkyl, or

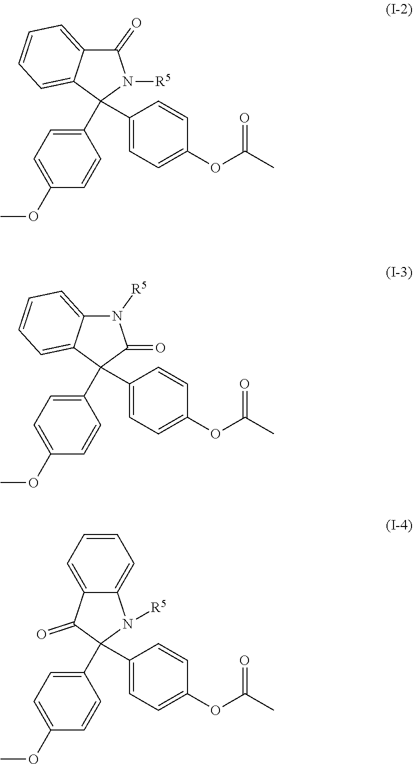

in which IV is a C₁- to C₄-alkyl radical, aralkyl radical or aryl radical, preferably a methyl radical or phenyl radical, most preferably a methyl radical,
for production of a laser-engravable film.

All details relating to the polycarbonates or copolycarbonates of the formula (Ia), (I-2), (I-3) or (I-4) can accordingly be inferred from those described in association with the film of the invention. All details relating to the method of laser engraving for coloring of the film have been described above and are likewise applicable to the use.

The invention further relates to a layer construction comprising at least the following layers:
S1. a film of the invention,
S2. optionally a further film,
S3. optionally a further film of the invention,
S4. optionally a paper or board layer.

The film of the invention has been described above. All details relating to the film, such as feedstocks, statements of amount, shapes and thicknesses, are likewise applicable to the films in the layer construction.

The further film may be any film that the person skilled in the art would use for the purpose. The further film is preferably selected from the group consisting of a polyurethane film, a polyester film, a polyacrylate film, a polycarbonate film, a silicone film or a combination of at least two of these.

In a preferred configuration of the layer construction, the layer construction includes a further film S2., wherein the further film S2 includes a thermoplastic selected from polymers of ethylenically unsaturated monomers and/or polycondensates of bifunctional reactive compounds, preferably one or more polycarbonates or copolycarbonates based on diphenols, poly- or copolyacrylates and poly- or copolymethacrylates, poly- or copolymers of styrene, thermoplastic polyurethane(s) and polyolefin(s), poly- or copolycondensates of terephthalic acid having a fraction of cyclohexane-1,4-dimethanol, cyclohexane-1,3-dimethanol and/or 2,2,4,4-tetramethylbutane-1,3-diol, preferably cyclohexane-1,4-dimethanol and/or cyclohexane-1,3-dimethanol, poly- or copolycondensates of naphthalenedicarboxylic acid, poly- or copolycondensates of at least one cycloalkyldicarboxylic acid, mixtures thereof or blends thereof, more preferably one or more polycarbonates or copolycarbonates based on diphenols or blends containing at least one polycarbonate or copolycarbonate.

The further film preferably corresponds to the construction and properties as described above for the further film in association with the film of the invention.

The paper or board layer S4. may be any paper or board layer that the person skilled in the art would use for this purpose.

In a preferred embodiment of the layer construction, the layer construction comprises a further layer containing at least one thermoplastic and at least one laser-sensitive additive. The additive is preferably a black pigment, more preferably carbon black, or a color pigment as described above in association with the coloring of the film of the invention. All details relating to the black pigments and color pigments are likewise applicable to the layer construction.

In the figures

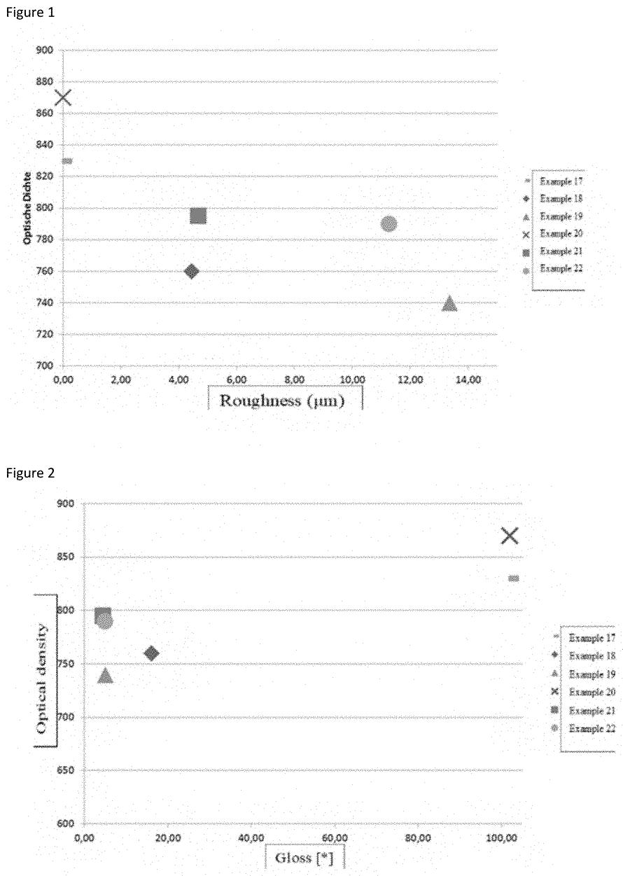

FIG. 1 Diagram of the comparison of the roughness and optical density of films according to the invention and not according to the invention

FIG. 2 Diagram of the comparison of the gloss and optical density of films according to the invention and not according to the invention

The films according to the invention are notable for higher optical density compared to the comparative films not according to the invention, as can be seen from FIGS. 1 and 2. Optical density was ascertained using the Techkon DENS color densitometer according to the recommendations of DIN 5033 Parts 1-9: Colorimetry and the calculations according to ISO 5-3:2009 (E): Photography—Measuring Optical Density—Part 3.

### EXAMPLES

### Example 1

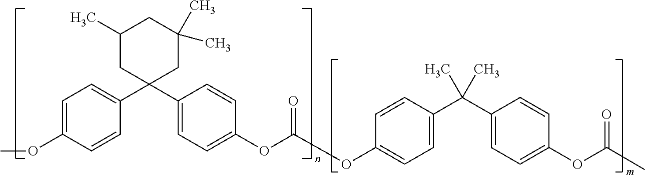

183.3 g (0.80 mol) of bisphenol A (2,2-bis(4-hydroxyphenyl)propane), 61.1 g (0.20 mol) of 1,1-bis(4-hydroxyphenyl)-3,3,5-trimethylcyclohexane, 336.6 g (6 mol) of KOH and 2700 g of water were dissolved with stirring in an inert gas atmosphere. A solution of 1.88 g of phenol in 2500 ml of methylene chloride was then added. 198 g (2 mol) of phosgene were introduced into the well-stirred solution at pH 13 to 14 and 21° C. to 25° C. 1 ml of ethylpiperidine was then added and the mixture was stirred for 45 min. The bisphenoxide-free aqueous phase was removed and the organic phase acidified with phosphoric acid, neutralized by washing with water and freed of solvent. The polycarbonate showed a relative solution viscosity of 1.255.

The glass transition temperature of the polymer was determined as 157° C. (DSC).

### Example 2

As in example 1, a mixture of 127.1 g (0.56 mol) of bisphenol A and 137.7 g (0.44 mol) of 1,1-bis(4-hydroxyphenyl)-3,3,5-trimethylcyclohexane was converted to the polycarbonate.

The polycarbonate showed a relative solution viscosity of 1.263.

The glass transition temperature of the polymer was determined as 167° C. (DSC).

### Example 3

As in example 1, a mixture of 149.0 g (0.65 mol) of bisphenol A and 107.9 g (0.35 mol) of 1,1-bis(4-hydroxyphenyl)-3,3,5-trimethylcyclohexane was converted to the polycarbonate.

The polycarbonate showed a relative solution viscosity of 1.263.

The glass transition temperature of the polymer was determined as 183° C. (DSC).

### Example 4

As in example 1, a mixture of 91.6 g (0.40 mol) of bisphenol A and 185.9 g (0.60 mol) of 1,1-bis(4-hydroxyphenyl)-3,3,5-trimethylcyclohexane was converted to the polycarbonate.

The polycarbonate showed a relative solution viscosity of 1.251.

The glass transition temperature of the polymer was determined as 204° C. (DSC).

### Example 5

As in example 1, a mixture of 44.2 g (0.19 mol) of bisphenol A and 250.4 g (0.81 mol) of 1,1-bis(4-hydroxyphenyl)-3,3,5-trimethylcyclohexane was converted to the polycarbonate.

The polycarbonate showed a relative solution viscosity of 1.248.

The glass transition temperature of the polymer was determined as 216° C. (DSC).

### Example 6: Compounding a Masterbatch for Production of the Layer Containing a Thermoplastic and an Antistat Additive

Production of the antistat additive compound was conducted with conventional twin-screw compounding extruders (e.g. ZSK 32) at processing temperatures of 250 to 330° C. that are customary for polycarbonate.

A masterbatch having the following composition was compounded and subsequently pelletized:
90% by weight of polycarbonate from example 3
10% by weight of N,N,N,N-dimethyldiisopropylammonium perfluorobutanesulfonate.

### Examples 7 to 10 of Film Extrusion

The films were extruded in a width of 450 mm using the plastic from example 3.

The system used consisted of
an extruder having a screw of diameter (D) 75 mm and length 33×D. The screw has a devolatilization zone;
a melt pump;
a crosshead;
a slot die of width 450 mm;
a three-roll smoothing calendar with horizontal roller orientation, wherein the third roller can swivel by +/−45° relative to the horizontal;
a roll conveyor;
thickness measurement;
a device for double-sided application of protective film;
a takeoff device;
winding station.

The respective pellet material was supplied to the extruder hopper. The material was melted and conveyed in the barrel/screw plastifying system of the extruder. The material melt was supplied to the smoothing calender, the rolls of which, or the cooling liquid supplied and removed for cooling of the rolls, had the temperature specified in table 1. The final shaping and cooling of the film was effected on the smoothing calender (consisting of three rolls). Structuring of the film surfaces was accomplished using a rubber roll (no. 4 or surface), polished chromium roll (no. 1 surface) or structured steel roll (no. 2 and 6 surface). The rubber roll used for texturing the film surface is described in U.S. Pat. No. 4,368,240 to Nauta Roll Corporation. Subsequently, the film was transported through a takeoff. Thereafter, it is optionally possible to apply a protective PE film to both sides and to wind up the film.

TABLE 0
Temperature profile of the extruder and die

| Process parameter | Target value (° C.) | Actual value (° C.) |
|---|---|---|
| Barrel zone 1 | 230.0 | 217.0 |
| Barrel zone 2 | 290.0 | 289.0 |
| Barrel zone 3 | 295.0 | 294.0 |
| Devolatilization zone 4 | 270.0 | 269.0 |
| Barrel zone 5 | 305.0 | 304.0 |
| Barrel zone 6 | 310.0 | 309.0 |
| Two-piece flange zone 7 | 320.0 | 317.0 |
| Flange before pump zone 8 | 320.0 | 333.0 |
| Flange after pump zone 9 | 320.0 | 318.0 |
| Flange zone 10 | 320.0 | 323.0 |
| Crosshead zone 11 | 320.0 | 314.0 |
| Melt conduit zone 12 | 320.0 | 314.0 |
| Melt conduit zone 13 | 330.0 | 330.0 |
| Right-hand nozzle zone 14 | 323.0 | 321.0 |
| Middle nozzle zone 15 | 330.0 | 330.0 |
| Left-hand nozzle zone 16 | 320.0 | 328.0 |
| Melt pump zone 17 | | 270° C. |

TABLE 1
Running speed and temperature profile of the rolls

| Linear speed W2: | | 3.70 m/min | |
|---|---|---|---|
| | | T of the cooling liquid (water here) | |
| Roll | Running | Upstream of contact | Downstream of contact |
| number | speed | with the melt | with the melt |
| Roll 1: | 1.0 m/min | 100-112° C. | 40° C. |
| Roll 2: | 1.5 m/min | 120° C. | 100° C. |
| Roll 3: | 1.00 m/min | 130° C. | 100° C. |

| | |
|---|---|
| Draw rate: | 0.992 m/min |

TABLE 2
Surface textures of example films 7 to 10″

| | Surface texture | Composition | |
|---|---|---|---|
| Example 7 | 1-4 | 100% polymer from example 3 | Comparative example |
| | | | (not according to the invention) |
| Example 8 | 6-2 | 100% polymer from example 3 | Comparative example |
| | | | (not according to the invention) |
| Example 9 | 1-4 | 90% polymer from example 3 | according to the invention |
| | | 10% compound from example 6 | |
| Example 10 | 6-2 | 90% polymer from example 3 | according to the invention |
| | | 10% compound from example 6 | |
| Example 10′ | 7-2 | 100% polymer from example 3 | Comparative example |
| | | | (not according to the invention) |
| Example 10″ | 7-2 | 90% polymer from example 3 | not according to the invention |
| | | 10% compound from example 6 | |

Films of thickness 100 μm were extruded.

### Examples 11 to 16: Toner Printing

A DIN A4 film specimen of examples 7 to 10 was printed with an HP color laser printer (printer model: Ricoh MP C 3003). The film was printed on the side with the side named in each case.

Print pattern: full-area black print

Resolution of the print pattern: 600 dpi.

The films according to the invention have impeccable printability and showed a faultless printed image, by contrast with the films not according to the invention, which warped in the printing operation and had distortions in the film.

TABLE 3
Surface textures of example films 11 to 16″

Description

| | | |
|---|---|---|
| Example 11 | No. 1 side printed of film from example 7 | Comparative example |
| | | (not according to the invention) |
| Example 12 | No. 4 side printed of film from example 7 | Comparative example |
| | | (not according to the invention) |
| Example 13 | No. 6 side printed of film from example 8 | Comparative example |
| | | (not according to the invention) |
| Example 14 | No. 1 side printed of film from example 9 | according to the invention |
| Example 15 | No. 4 side printed of film from example 9 | according to the invention |
| Example 16 | No. 6 side printed of film from example 10 | according to the invention |
| Example 16′ | No. 7 side printed of film from example 10′ | Comparative example |
| | | (not according to the invention) |
| Example 16″ | No. 7 side printed of film from example 10″ | according to the invention |

### Examples 17 to 24: Card Lamination

The printed films from example 11 to 16″ were placed between two further films based on Makrolon 3108® polycarbonate from Covestro AG. The film stack was placed into a Burkle lamination press and laminated under pressure and temperature. Lamination was effected with the following parameters:

Temperature: 195° C.

Low hold pressure during the heating time: 15 N/cm²

Heating time: 8 minutes.

High pressure during the lamination: 300 N/cm²

Lamination time: 2 minutes.

Subsequently, cooling of the press was initiated. Cooling was effected with continued application of pressure. On attainment of a temperature of 38° C., the press was opened.

Evaluation of Optical Density

TABLE 4
Evaluation of optical density and gloss of examples 17 to 24

| | | | | | Optical density, |
|---|---|---|---|---|---|
| | | | | | printed side |
| Description | | | Roughness | Gloss | downward, black |
| Example 17 | No. 1 side printed of | Comparative example | 0.00 | 102.00 | 82.6 |
| | film from example 7 | (not according to the | | | |
| | | invention) | | | |
| Example 18 | No. 4 side printed of | Comparative example | 4.44 | 16.00 | 80.4 |
| | film from example 7 | (not according to the | | | |
| | | invention) | | | |
| Example 19 | No. 6 side printed of | Comparative example | 13.36 | 4.90 | 80.2 |
| | film from example 8 | (not according to the | | | |
| | | invention) | | | |
| Example 20 | No. 1 side printed of | according to the | 0.00 | 102.00 | 83.0 |
| | film from example 9 | invention | | | |
| Example 21 | No. 4 side printed of | according to the | 4.67 | 4.42 | 79.8 |
| | film from example 9 | invention | | | |
| Example 22 | No. 6 side printed of | according to the | 11.26 | 4.86 | 80.7 |
| | film from example | invention | | | |
| | 10 | | | | |
| Example 23 | No. 7 side printed of | Comparative example | 17.59 | 13.50 | 79.1 |
| | film from example | (not according to the | | | |
| | 10′ | invention) | | | |
| Example 24 | No. 7 side printed of | according to the | 28.54 | 12.00 | 79.6 |
| | film from example | invention | | | |
| | 10″ | | | | |

As can be inferred from table 4, either an increase or approximate matching of the optical density coupled with usually constant gloss values and an increase in optical density with constant roughness after the printing of the films according to the invention from examples 20 to 22 and 24 is apparent by comparison with examples 17 to 19 and 23 not according to the invention, in each case with respect to the corresponding composition. The results were shown visually for the representation of optical density at different roughnesses in FIG. 1 and at different gloss levels in FIG. 2 for examples 17 to 24. However, the crucial feature for films to be printed is the sharpness of the print. It should be noted here that there are regions of gloss and of roughness that produce a poor printed image, whereas the films of the invention will show a good to very good printed image, as can be inferred in table 5.

Evaluation of the Printed Image

TABLE 5
Evaluation of the printed image from examples 17 to 24

| Description | | Printed image |
|---|---|---|
| Example 17 | No. 1 side printed of | Blurred (−) |
| | film from example 7 | |
| Example 18 | No. 4 side printed of | Matt and cloudy (−) |
| | film from example 7 | |
| Example 19 | No. 6 side printed of | Matt and cloudy (−) |
| | film from example 8 | |
| Example 20 | No. 1 side printed of | Sharp and delimited (+) |
| | film from example 9 | |
| Example 21 | No. 4 side printed of | Sharp and delimited (+) |
| | film from example 9 | |
| Example 22 | No. 6 side printed of | Sharp and delimited (+) |
| | film from example 10 | |
| Example 23 | No. 7 side printed of | Matt and cloudy (−) |
| | film from example 10′ | |
| Example 24 | No. 7 side printed of | Sharp and delimited (+) |
| | film from example 10″ | |

1. A film comprising
i) 85% to 95% by weight of one of a polycarbonate or a copolycarbonate of the formula (Ia), (I-2), (I-3) or (I-4), where (Ia) 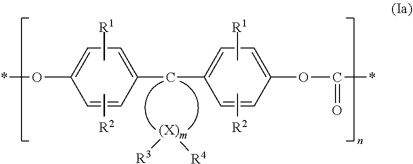
in which
R¹ and R² are independently hydrogen, halogen, C₁-C₈-alkyl, C₅-C₆-cycloalkyl, C₆-C₁₀-aryl, C₇-C₁₂-aralkyl,
m is an integer from 4 to 7,
R³ and R⁴ can be are chosen individually for each X and are independently hydrogen or C₁-C₆-alkyl and
X is carbon,
with the proviso that for at least one atom X, R³ and R⁴ both represent alkyl,
or wherein 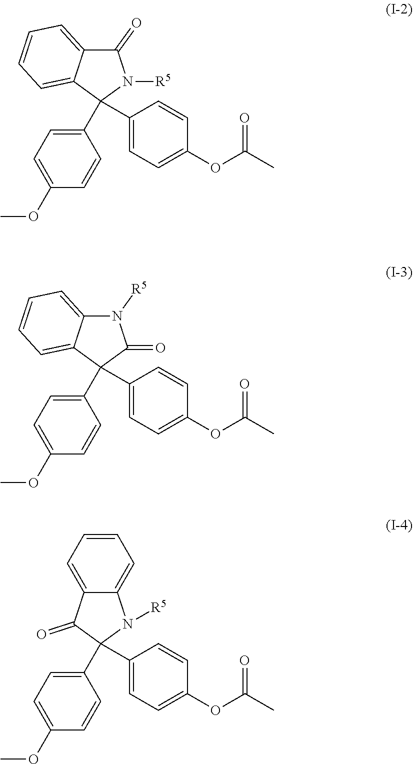
in which R⁵ is a C₁- to C₄-alkyl radical, aralkyl radical or aryl radical,
ii) 0.1% to 5% by weight of a first additive;
iii) optionally 0.1% to 15% by weight of a second additive different than the first additive;
wherein the first additive ii) comprises or is an antistatic compound.

2. The film as claimed in claim 1, wherein the first additive ii) is selected from the group consisting of quaternary ammonium or phosphonium salts of a partly fluorinated or perfluorinated organic acid or quaternary ammonium or phosphonium hexafluorophosphates, and mixtures of at least two of these.

3. The film as claimed in claim 1, wherein the antistatic compound is selected from the group consisting of quaternary ammonium salts of a partly fluorinated or perfluorinated organic acid or quaternary ammonium hexafluorophosphates, and mixtures of at least two of these.

4. The film as claimed in claim 1, wherein the polycarbonate or copolycarbonate has an average molecular weight Mw within a range from 10 000 to 500 000 g/mol.

5. The film as claimed in claim 1, wherein the polycarbonate or copolycarbonate has been prepared partly from the starting materials selected from the group consisting of: 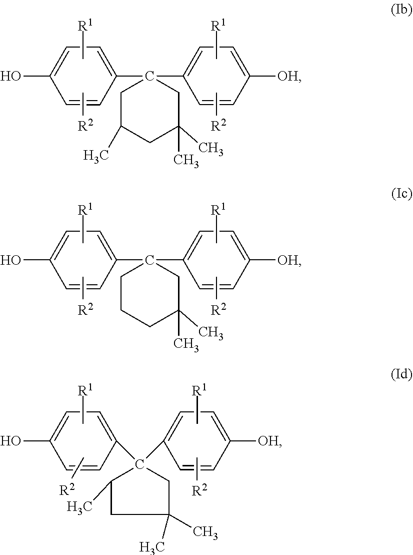
and mixtures of at least two of these.

6. The film as claimed in claim 1, wherein the polycarbonate or copolycarbonate includes the starting compound (Ib) within a range from 10% by weight to 90% by weight based on the total mass of the polycarbonate or copolycarbonate, or the polycarbonate or copolycarbonate has a molar ratio of (Ib) to other bisphenol A derivatives within a range from 1:10 to 10:1.

7. The film as claimed in claim 1, wherein the film has at least one of the following properties:
(A) roughness in accordance with ISO 4288:1996 within a range from 2 μm to 30 μm;
(B) transparency within a range from 2% to 92%, measured to ISO 13468-2:2006-07;
(C) gloss within a range from 10 to 110 to ISO 2813, 2015-02;
(D) scratch resistance within a range from 4B to 3H, measured according to DIN EN ISO 15184-2011-05;
(E) a Vicat softening temperature within a range from 160° C. to 230° C., according to ISO 306:2004 (method B120 50N; 120° C./h);
(F) surface resistance <10¹⁴Ω, according to DIN IEC 93:1980 (from Fischer).

8. The film as claimed in claim 1, wherein the further additive is selected from the group consisting of a dye, a pigment, and a combination of these.

9. The film as claimed in claim 1, wherein the pigment is selected from the group consisting of titanium dioxide, zirconium dioxide, calcium carbonate, barium sulfate, and a mixture of at least two of these.

10. The film as claimed in claim 1, wherein the further additive is introduced into the film by a process having at least the following steps:
D1. at least partly coating the film with a layer containing a dye or pigment,
D2. at least partly irradiating the film from D1. with focused nonionizing electromagnetic radiation,
wherein there is partial coloring of the film only at the sites irradiated in step D2.

11. A security document including the film as claimed in claim 1 having security-relevant data.

12. In a process for production of a laser-engravable film, the improvement comprising including a polycarbonate or a copolycarbonate of the formula 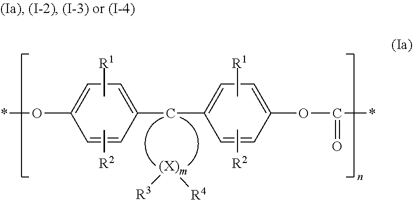
in which
R¹ and R² are independently hydrogen, halogen, C₅-C₆-cycloalkyl, C₆-C₁₀-aryl, and C₇-C₁₂-aralkyl,
m is an integer from 4 to 7,
R³ and R⁴ are chosen individually for each X and are independently hydrogen or C₁-C₆-alkyl and
X is carbon,
with the proviso that, on at least one atom X, R³ and R⁴ are both alkyl, or 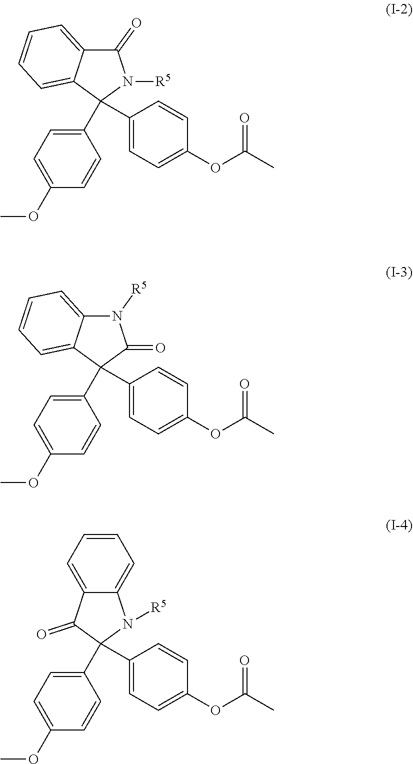
in which R⁵ is a C₁- to C₄-alkyl radical, aralkyl radical or aryl radical.

13. A layer construction comprising the following layers:
S1. a film as claimed in claim 1,
S2. optionally a further layer or film,
S3. optionally a further film as claimed in claim 1,
S4. optionally a paper or board layer.

14. The layer construction as claimed in claim 13, comprising at least one further film S2., wherein the further film S2. includes a thermoplastic selected from one or more polycarbonates or copolycarbonates based on diphenols, poly- or copolyacrylates and poly- or copolymethacrylates, poly- or copolymers of styrene, thermoplastic polyurethane(s) and polyolefin(s), poly- or copolycondensates of terephthalic acid having a fraction of cyclohexane-1,4-dimethanol, cyclohexane-1,3-dimethanol and/or 2,2,4,4-tetramethylbutane-1,3-diol, and blends containing at least one polycarbonate or copolycarbonate.

15. The layer construction as claimed in claim 14, characterized in that the layer construction comprises a further layer containing at least one thermoplastic and at least one laser-sensitive additive.
